(19) United States
(12) Patent Application Publication
(10) Pub. No.: US 2026/0103030 A1
(43) Pub. Date: Apr. 16, 2026

(54) PNEUMATIC TIRE

(71) Applicant: Toyo Tire Corporation, Hyogo (JP)

(72) Inventor: Tsuyoshi FUJIOKA, Hyogo (JP)

(21) Appl. No.: 19/340,111

(22) Filed: Sep. 25, 2025

(30) Foreign Application Priority Data
Oct. 10, 2024 (JP) 2024-177580

(51) Int. Cl. B60C 11/04; B60C 11/03

(52) U.S. Cl. CPC B60C 11/047; B60C 2011/0374; B60C 2011/039

(57) ABSTRACT

The pneumatic tire has a tread pattern including a plurality of ribs partitioned by shoulder primary grooves and a center primary groove. The ribs include shoulder ribs positioned at respective end sides in the tire axial direction in relation to the shoulder primary groove, and a center rib positioned at a center side in the tire axial direction in relation to the shoulder primary groove. The center primary groove has a plurality of groove-bottom protrusions formed intermittently in a tire circumferential direction. The groove-bottom protrusion is longer in the tire circumferential direction than in the tire axial direction, and all or a part of the plurality of groove-bottom protrusions exist on a line of extension of the axial groove.

### CROSS REFERENCE TO RELATED APPLICATION

This application claims priority to Japanese Patent Application No. 2024-177580 filed on Oct. 10, 2024, which is incorporated herein by reference in its entirety including the specification, claims, drawings, and abstract.

### TECHNICAL FIELD

The present disclosure relates to a pneumatic tire, and in particular to a tread structure of a pneumatic tire.

### BACKGROUND

In related art, pneumatic tires are widely known which have a tread pattern including a circumferential groove which extends in a tire circumferential direction, an axial groove which extends in a tire axial direction, and a plurality of blocks divided by the grooves (refer, for example, to JP 2015-512352 A).

In such a tire having a rib-type pattern, traction performance of the tire is improved by having an axial groove on a rib, so that the number of traction elements is increased. However, as a result of studies by the present inventors, it was found that, when the axial groove is formed on the rib, rigidity of the block is locally reduced due to the axial groove, such that the block tends to wear unevenly.

### SUMMARY

According to one aspect of the present disclosure, there is provided a pneumatic tire comprising a tread pattern including shoulder primary grooves provided at respective end sides in a tire axial direction; a center primary groove provided at a center side in the tire axial direction in relation to the shoulder primary groove; and a plurality of ribs partitioned by the shoulder primary grooves and the center primary groove, wherein an axial groove which extends primarily in the tire axial direction is formed on the plurality of ribs, the axial groove includes a point of inflection, and is connected to at least one of the shoulder primary groove and the center primary groove, adjacent ones of the axial grooves of the plurality of ribs are disposed in a shifted manner in a tire circumferential direction, the ribs include shoulder ribs positioned at respective end sides in the tire axial direction in relation to the shoulder primary groove, and a center rib positioned at a center side in the tire axial direction in relation to the shoulder primary groove, the center primary grooves has a plurality of groove-bottom protrusions formed intermittently in the tire circumferential direction, the groove-bottom protrusion is longer in the tire circumferential direction than in the tire axial direction, and all or a part of the plurality of groove-bottom protrusions exists on a line of extension of the axial groove.

According to a pneumatic tire of an aspect of the present disclosure, uneven wear of a rib forming the tread pattern can be suppressed. According to the present disclosure, a pneumatic tire can be provided which has superior traction performance and in which uneven wear of the block is effectively suppressed.

### BRIEF DESCRIPTION OF DRAWINGS

Embodiments of the present disclosure will be described based on the following figures, wherein:

FIG. 1 is a plan view showing a tread of a pneumatic tire according to an embodiment of the present disclosure;

FIG. 2 is a cross-sectional diagram of a location surrounded by an ellipse A in FIG. 1;

FIG. 3 is a cross-sectional diagram of a location surrounded by an ellipse B in FIG. 1;

FIG. 4 is an enlarged schematic diagram showing a portion surrounded by a frame of a dash-dot line in FIG. 1; and

FIG. 5 is a perspective diagram showing the portion surrounded by the frame of the dash-dot line in FIG. 1.

### DESCRIPTION OF EMBODIMENTS

A pneumatic tire according to an embodiment of the present disclosure will now be described in detail with reference to the drawings. The embodiment described herein is merely exemplary, and the present disclosure is not limited to the embodiment described below. In addition, configurations in which constituent elements of the embodiments described below are selectively combined are within the scope of the present disclosure.

A pneumatic tire 1 according to an embodiment of the present disclosure has a typical structure of a pneumatic tire except for a tread 2, which is a portion contacting a road surface. Specifically, bead portions including a bead core and a bead filler are provided on respective sides in a tire axial direction, and a carcass ply is provided from one bead portion in the tire axial direction to the other bead portion. On a radially outer side of the carcass ply, a belt is provided, and the tread 2 is provided on a radially outer side of the belt. An inner liner is provided on an inner side of the carcass ply, and a side wall rubber is provided on respective sides in the tire axial direction of the carcass ply. In addition to the above-described elements, a plurality of rubber members are provided, and the pneumatic tire is formed.

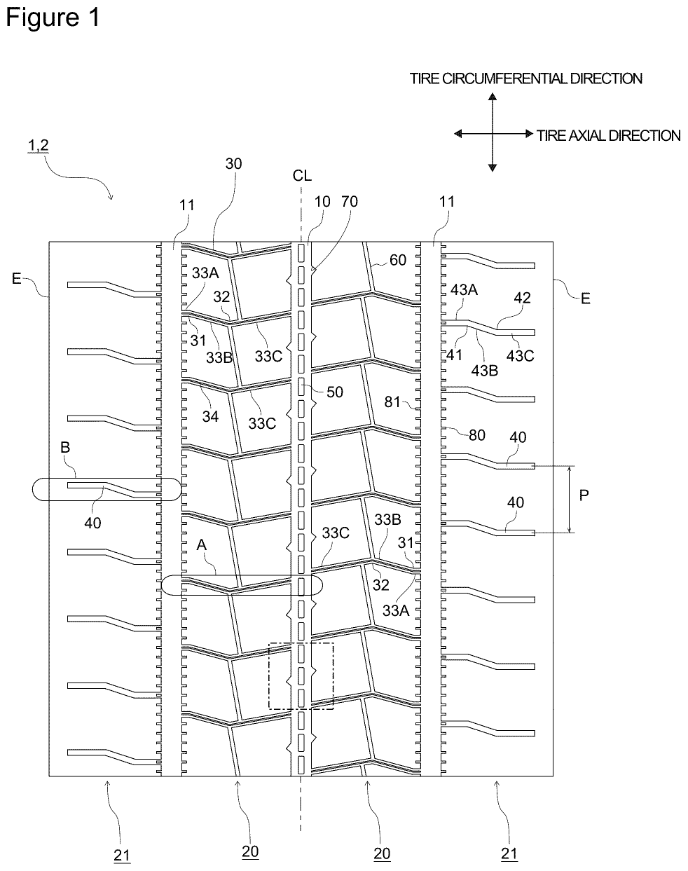

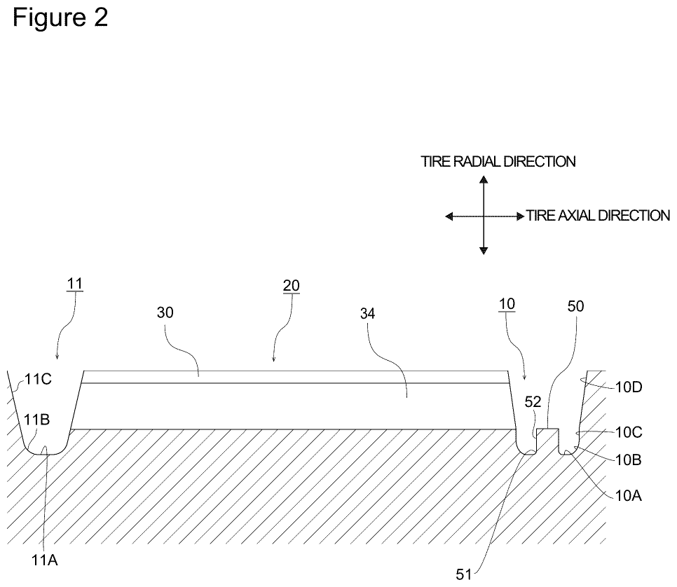

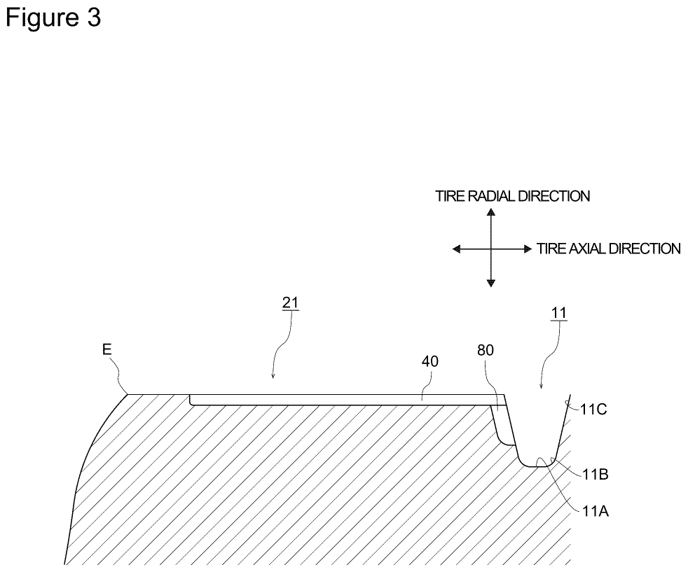

With reference to FIGS. 1 to 3, the tread 2 of the pneumatic tire 1 will now be described. FIG. 1 is a plan view showing the tread 2 of the pneumatic tire 1 according to the present embodiment. FIG. 2 is a cross-sectional diagram showing a center primary groove 10, a shoulder primary groove 11, an axial groove 30, and the like, surrounded by an ellipse A in FIG. 1. FIG. 3 is a cross-sectional diagram showing the shoulder primary groove 11, an axial groove 40, and the like surrounded by an ellipse B in FIG. 1. In FIG. 1, only a ground-contacting surface including a ground-contacting end E is shown. For convenience of explanation, the right side of the page of FIG. 1 will be referred to as the right side of the pneumatic tire 1, and the left side of the page of FIG. 1 will be referred to as the left side of the pneumatic tire 1.

The ground-contacting ends E of the pneumatic tire 1 are defined as ends in the tire axial direction of a region which contacts a flat road surface (ground-contacting surface) when a predetermined load is applied in a state in which an unused tire is equipped on a regular rim, and air is filled to achieve a regular internal pressure. The predetermined load is a load corresponding to 88% of a regular load. In the present embodiment, ends on outer sides in the tire axial direction of the ground-contacting surface of a shoulder rib 21 to be described later are the ground-contacting ends E.

Here, the “regular rim” refers to a rim determined by a tire standard, and is defined as a “standard rim” in JATMA, and a “Measuring Rim” in TRA and ETRTO. The “regular internal pressure” is defined as a “maximum pneumatic pressure” in JATMA, a maximum value described in the table, “TIRE LOAD LIMITS AT VARIOUS COLD INFLATION PRESSURES” in TRA, and an “INFLATION PRESSURE” in ETRTO. The “regular load” is defined as a “maximum load capability” in JATMA, a maximum value described in the table, “TIRE LOAD LIMITS AT VARIOUS COLD INFLATION PRESSURES” in TRA, and a “LOAD CAPACITY” in ETRTO.

The pneumatic tire 1 can be applied in tires for various vehicles such as tires for passenger cars, and heavy-load tires for trucks, buses, and light trucks (for example, SUV vehicles and pickup trucks). Further, the usage is not particularly limited, and the usage may be summer tires (tires for summertime), winter tires (tires for winter seasons), all-season tires, and the like.

The pneumatic tire 1 is a point-symmetric tire having no designation of the direction of equipping on a vehicle, and the shapes of the tread pattern and the tire side surface do not vary when the tire is equipped on the vehicle in either direction. The shapes of the tread pattern and the tire side surface of the pneumatic tire 1 are shapes obtained by rotating the shape 180° at the left and the right of a tire equator CL. The tire equator CL is a virtual line parallel to a tire circumferential direction, passing through a center in the tire axial direction of the tread 2.

As shown in FIG. 1, the pneumatic tire 1 has the tread 2 including a plurality of primary grooves provided along the tire circumferential direction, and a plurality of ribs partitioned by the primary grooves. The tread 2 is formed with the shoulder primary grooves 11 provided at respective end sides in the tire axial direction, and the center primary groove 10 provided at the center in the tire axial direction relative to the shoulder primary groove 11. In other words, the tread 2 comprises shoulder primary grooves 11 provided on the sides of the ground-contacting ends E, and a center primary groove 10 provided at the tire equator CL relative to the shoulder primary grooves 11.

The center primary groove 10 and the shoulder primary groove 11 are formed in a straight pattern along the tire circumferential direction. In addition, the center primary groove 10 and the shoulder primary groove 11 may have similar lengths in the tire axial direction (groove width), and the groove width of the center primary groove 10 may be larger than the groove width of the shoulder primary groove 11. Further, the center primary groove 10 and the shoulder primary groove 11 may have similar depths in a tire radial direction. The center primary groove 10 and the shoulder primary groove 11 are the deepest grooves among the grooves provided on the tread 2, and are grooves having the widest groove widths among the grooves provided on the tread 2 and extending in the circumferential direction.

The tread 2 has shoulder ribs 21 partitioned by the center primary groove 10 and the shoulder primary grooves 11 and positioned at respective end sides in the tire axial direction (sides of the ground-contacting ends E) in relation to the shoulder primary grooves 11, and center ribs 20 partitioned by the center primary groove 10 and the shoulder primary grooves 11 and positioned at a center side in the tire axial direction (side of the tire equator CL) in relation to the shoulder primary grooves 11. In the present embodiment, the tread 2 has two shoulder primary grooves 11 and one center primary groove 11 provided along the tire equator CL, and two center ribs 20 and two shoulder ribs 21 partitioned by the shoulder primary grooves 11 and the center primary groove 10.

A length in the tire axial direction (width) of the shoulder rib 21 is equal to, or greater than or equal to, a length in the tire axial direction of the center rib 20. Specifically, the length in the tire axial direction of the shoulder rib 21 is desirably greater than or equal to 100% and less than or equal to 135% of the length in the tire axial direction of the center rib 20. The length in the tire axial direction of the shoulder rib 21 may be, for example, 103% of the length in the tire axial direction of the center rib 20. With such a configuration, the width of the shoulder rib 21 can be secured, and occurrence of uneven wear can be suppressed.

On the plurality of ribs, an axial groove which extends primarily in the tire axial direction is formed, and the axial groove includes a point of inflection and is connected to at least one of the shoulder primary groove 11 and the center primary groove 10. Specifically, axial grooves 30 and 40 which extend primarily in the tire axial direction are formed on the center rib 20 and the shoulder rib 21, respectively. Each of the axial grooves 30 and 40 includes a point of inflection, and is connected to at least one of the center primary groove 10 and the shoulder primary groove 11. The axial groove 30 is desirably provided such that the center primary groove 10 and the shoulder primary groove 11 communicate with each other. When a plurality of center primary grooves 10 are formed, the axial groove 30 is desirably provided such that the center primary grooves 10 communicate with each other. More specifically, a plurality of axial grooves 30 are provided with a spacing therebetween on the center rib 20, and, similarly, a plurality of axial grooves 40 are provided with a spacing therebetween on the shoulder rib 21. With the pneumatic tire 1 having the axial grooves 30 and 40 on the center rib 20 and the shoulder rib 21, respectively, the number of traction elements is increased, and the traction performance can thus be improved.

The axial groove 30 may have one point of inflection or a plurality of points of inflection, and regions between the shoulder primary groove 11, the center primary groove 10, and the point of inflection are formed by straight lines. In the present embodiment, the axial groove 30 is formed from two points of inflection 31 and 32, and three straight-line portions 33. That is, the axial groove 30 is formed from a first straight-line portion 33A parallel to the tire axial direction, and opened to the shoulder primary groove 11, a second straight-line portion 33B formed between the point of inflection 31 and the point of inflection 32, and a third straight-line portion 33C extending from the point of inflection 32 in an inclined manner with respect to the tire axial direction, and opened to the center primary groove 10. With the second straight-line portion 33B including a tire circumferential component, preferable skid resistance can be secured.

A depth of the axial groove 30 is greater than or equal to 10% and less than or equal to 30% of the depth of the center primary groove 10, and is desirably greater than or equal to 15% and less than or equal to 25% of the depth of the center primary groove 10. The depth of the axial groove 30 may be, for example, 15% of the depth of the center primary groove 10. With such a configuration, the traction performance can be improved more effectively.

In the axial groove 30, a sipe 34 having respective ends connected to at least one of the center primary groove 10 and the shoulder primary groove 11 may be formed at a bottom of the groove. The sipe 34 is desirably provided such that the center primary groove 10 and the shoulder primary groove 11 communicate with each other. When a plurality of the center primary grooves 10 are formed, the sipe 34 is desirably provided such that the center primary grooves 10 communicate with each other. The sipe 34 is a groove having a narrower width than the axial groove 30, is provided at a center in a groove-width direction of the axial groove 30, and is bent at a position similar to the axial groove 30. In the present embodiment, the sipe 34 opens to the center primary groove 10 and the shoulder primary groove 11, and is formed over an entire length of the axial groove 30. With the pneumatic tire 1 having such a configuration, because the sipe 34 remains present even at the final stage of wear, the traction performance can be secured through the final stage of wear, and resistance to uneven wear can be secured.

A total depth of the axial groove 30 and the sipe 34 (that is, a length from the ground-contacting surface to a bottom of the sipe 34) is desirably greater than or equal to 50% and less than or equal to 90% of the depth of the center primary groove 10. The total depth of the axial groove 30 and the sipe 34 may be, for example, 70% of the depth of the center primary groove 10. With the pneumatic tire 1 having such a configuration, the traction performance at the final stage of wear and the resistance to uneven wear can be secured more effectively.

The axial groove 40 has one point of inflection or a plurality of points of inflection, and regions between the shoulder primary groove 11, the center primary groove 10, and the point of inflection are formed by straight edges. As shown in FIG. 3, the axial groove 40 is formed in a manner to be connected to the shoulder primary groove 11, and closed in the shoulder rib 21. In the present embodiment, the axial groove 40 is formed from two points of inflection 41 and 42, and three straight-line portions 43. That is, the axial groove 40 is formed from a first straight-line portion 43A parallel to the tire axial direction and opened to the shoulder primary groove 11, a second straight-line portion 43B formed between the point of inflection 41 and the point of inflection 42, and a third straight-line portion 43C extending from the point of inflection 42 in parallel to the tire axial direction, and closed in the shoulder rib 21. With the second straight-line portion 43B including a tire circumferential component, the skid resistance can be secured.

A depth of the axial groove 40 is greater than or equal to 5% and less than or equal to 30% of the depth of the shoulder primary groove 11, and is more desirably greater than or equal to 10% and less than or equal to 25% of the depth of the shoulder primary groove 11. The depth of the axial groove 40 may be, for example, 15% of the depth of the shoulder primary groove 11. With such a configuration, the traction performance can further improved.

The axial grooves 30 and 40 provided at adjacent positions of the center rib 20 and the shoulder rib 21 are desirably disposed in a shifted manner in the tire circumferential direction. For example, in the tread 2, the axial grooves 30 and 40 are disposed in such a manner that the axial grooves 30 and 40 adjacent in the tire axial direction do not have regions overlapping in the tire axial direction. The axial grooves 30 and 40 which are not adjacent may have regions overlapping in the tire axial direction, but desirably, all of the axial grooves 30 and 40 formed on the tread 2 are disposed so as to not overlap in the tire axial direction.

The axial grooves 30 and 40 are desirably disposed so that an amount of shift in the tire circumferential direction of the axial grooves 30 adjacent to each other over the center primary groove 10 is smaller than an amount of shift in the tire axial direction of the axial grooves 30 and 40 adjacent to each other over the shoulder primary groove 11. With such a configuration, the traction performance can be further improved in the center rib 20, and resistance to uneven wear can be further improved in the shoulder rib 21.

The amount of shift in the tire circumferential direction of the axial grooves 30 adjacent to each other over the center primary groove 10 is greater than or equal to 5% and less than or equal to 20% of a length in the tire circumferential direction of one pitch (pitch length), and may be, for example, 9% with respect to the length in the tire circumferential direction of one pitch (pitch length). In the present disclosure, the length in the tire circumferential direction of one pitch (pitch length) refers to a length in the tire circumferential direction of one repeating unit of the tread pattern, and is, for example, a spacing P in the tire circumferential direction of closure ends of two axial grooves 40 adjacent in the tire circumferential direction (refer to the shoulder rib 21 at the right side of FIG. 1). The length in the tire circumferential direction of one pitch (pitch length) may be such that the pitches are “equal pitches” in which all of the pitch length are equal in the tread 2, but from the viewpoint of improvement of quietness, the pitches are “variable pitches” (unequal lengths) in which the pitch length varies in the tire circumferential direction.

On the center rib 20, a narrow groove 60 is desirably provided which connects the axial grooves 30, and which is inclined in the tire axial direction. The narrow groove 60 opens only to the axial groove 30, and does not open to the center primary groove 10. In the present embodiment, the narrow groove 60 connects the point of inflection 32 of the axial groove 30 and the third straight-line portion 33C of the axial groove 30, which is adjacent in the tire circumferential direction. With the pneumatic tire 1 having such a configuration, the preferable skid resistance can be secured by the narrow groove 60 having a tire circumferential component.

When a straight line parallel to the tire circumferential direction is presumed, the narrow groove 60 is desirably inclined with an angle of greater than or equal to 5° and less than or equal to 30° with respect to the straight line. The straight line parallel to the tire circumferential direction is, for example, the tire equator CL. In the present embodiment, the narrow groove 60 is inclined with an angle of 10° with respect to the tire equator CL. Alternatively, the narrow groove 60 may be inclined to be perpendicular to the axial groove 30. That is, in the present embodiment, the narrow groove 60 may be inclined to be perpendicular to the third straight-line portion 33C. The direction of inclination of the narrow groove 60 is desirably the same direction for all of the narrow grooves 60 formed on the center rib 20. More desirably, the direction of inclination and the angle of inclination of the narrow grooves 60 are identical for all of the narrow grooves 60.

The depth of the narrow groove 60 is greater than or equal to 10% and less than or equal to 30% of the depth of the center primary groove 10, and the narrow groove 60 may be formed with a depth of, for example, 15% of the depth of the center primary groove 10. Further, the narrow groove 60 may be formed with the same depth as that of the axial groove 30, or with a different depth from that of the axial groove 30.

As shown in FIG. 2, the center primary groove 10 may include, in this order from the groove bottom, a groove-bottom surface 10A parallel to the tire axial direction, a curved surface 10B curved in a shape to be convex toward an inner side of the center rib 20, a flat surface 10C parallel to the tire radial direction, and an inclined surface 10D formed in an inclined manner from the tire radial direction. With the pneumatic tire 1 having the curved surface 10B between the groove-bottom surface 10A and the center rib 20, it becomes easier to distribute stress applied to the center rib 20.

Similarly, as shown in FIG. 3, the shoulder primary groove 11 may include, in this order from the groove bottom, a groove-bottom surface 11A parallel to the tire axial direction, a curved surface 11B curved in a shape to be convex toward an inner side of the center rib 20 or the shoulder rib 21, and an inclined surface 11C formed in an inclined manner from the tire radial direction. With the pneumatic tire 1 having the curved surface 11B between the groove-bottom surface 11A and the center rib 20 and between the groove-bottom surface 11A and the shoulder rib 21, it becomes easier to distribute the stress applied to the center rib 20 and the shoulder rib 21.

The center rib 20 has a notch 70 having a triangular shape opened to the center primary groove 10, at a center part of a block separated by the center primary groove 10 and the axial groove 30. The notch 70 may be formed, for example, at a center part of a gap in the tire circumferential direction between two axial grooves 30 of the center rib 20 which are adjacent to each other in the tire circumferential direction. The notches 70 which oppose each other over the center primary groove 10 are desirably disposed in a shifted manner in the tire circumferential direction. With the center rib 20 having the notch 70, the traction performance can be further improved. In addition, with the notches 70 disposed in the shifted manner in the tire circumferential direction, the resistance to uneven wear can be improved.

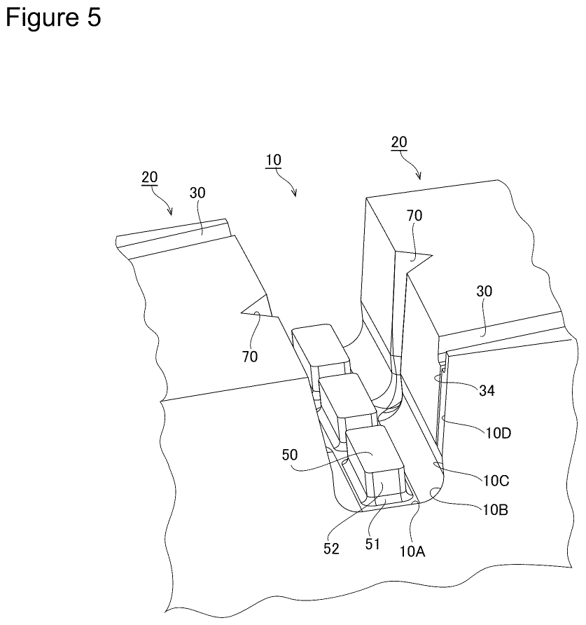

As shown in FIG. 5, the notch 70 is formed to pierce along the shape of the center primary groove 10 from the ground-contacting surface of the center rib 20 to the groove-bottom surface 10A. More specifically, the notch 70 having a triangular shape is formed to pierce, from the ground-contacting surface in this order, the inclined surface 10D, the flat surface 10C, and the curved surface 10B. A notch 70 is desirably formed along each surface. When the notch 70 is formed, the curved surface 10B of the center primary groove 10 extends in the tire circumferential direction, along the notch 70.

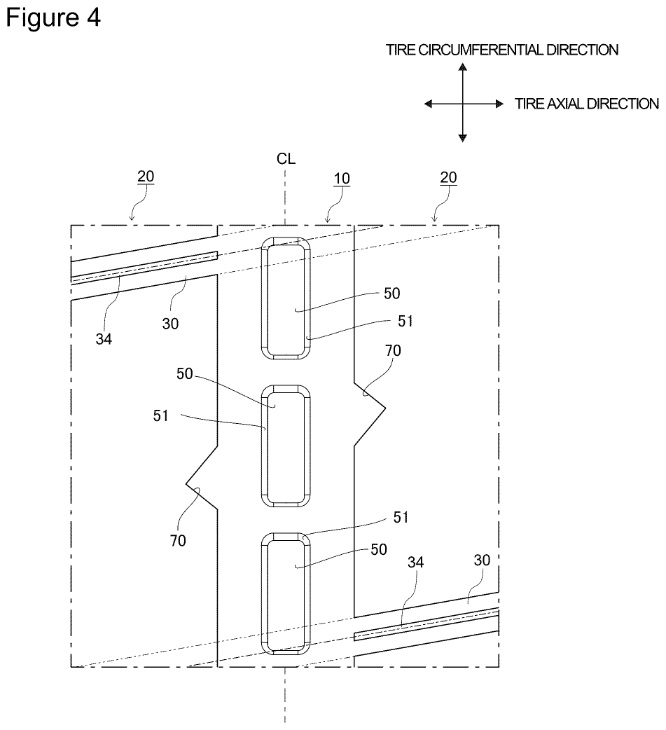

With reference further to FIGS. 4 and 5, the tread 2 according to an embodiment of the present disclosure will be described in further detail. FIG. 4 is an enlarged schematic diagram of the portion outlined in FIG. 1 by a dash-dot line. FIG. 5 is a perspective diagram showing the portion surrounded by the dash-dot line of FIG. 1. For clarity of illustration, the curved surface 10B of the center primary groove 10 is not shown in FIG. 4. The dash-dot line of FIG. 4 is a virtual line indicating a line of extension of the center line of the axial groove 30. A dash-dot-dot line of FIG. 4 is a virtual line indicating a line of extension of an outer shape line of the axial groove 30.

The center primary groove 10 has a plurality of groove-bottom protrusions 50 formed intermittently in the tire circumferential direction. The groove-bottom protrusion 50 has a shape longer in the tire circumferential direction than in the tire axial direction. The groove-bottom protrusion 50 is a protrusion formed to protrude from the groove bottom of the center primary groove 10, and, in the present embodiment, is formed with a shape in the plan view of an approximate quadrangular shape. More specifically, when the groove-bottom protrusion 50 is viewed in the plan view, the groove-bottom protrusion 50 has a shape with respective corners of the quadrangle chamfered. The shape of the groove-bottom protrusion 50 is not limited to the approximate quadrangular shape in the plan view, and an arbitrary shape such as an elliptical shape and a polygonal shape may be employed. With the pneumatic tire 1 having such a configuration, stone-bite can be suppressed, and the rigidity of a portion having the rigidity reduced due to the formation of the axial groove 30 can be improved for a better rigidity balance, resulting in improvement in resistance to uneven wear.

All or a part of the plurality of groove-bottom protrusions 50 exists on the line of extension of the axial groove 30. When the tread 2 is viewed in the plan view, the groove-bottom protrusion 50 is provided on a line of extension of the center line of the axial groove 30 (the dash-dot line of FIG. 4). That is, the groove-bottom protrusion 50 is provided to overlap in the tire radial direction the line of extension of the center line of the axial groove 30. When the sipe 34 is provided at the center in the groove width direction of the axial groove 30, the groove-bottom protrusion 50 may be provided on a line of extension of the sipe 34. In addition, the groove-bottom protrusion 50 may be provided in such a manner that a part of the groove-bottom protrusion 50 exists in a region defined by the line of extension of the outer shape line of the axial groove 30 (the dash-dot-dot line of FIG. 4). In this case, the groove-bottom protrusion 50 does not need to be provided in a manner to overlap in the tire radial direction the line of extension of the center line of the axial groove 30.

The groove-bottom protrusion 50 is desirably provided on the center line of the center primary groove 10. That is, the groove-bottom protrusion 50 is desirably provided to not lean to either of the center ribs 20 in the center primary groove 10. In the present embodiment, the groove-bottom protrusion 50 is desirably formed on the tire equator CL. In addition, the groove-bottom protrusion 50 is provided, for example, on the groove-bottom surface 10A of the center primary groove 10.

All or a part of the plurality of groove-bottom protrusions 50 are present at a position opposing the notch 70. Specifically, the center primary groove 10 has the groove-bottom protrusion 50 at a position opposing the notch 70 in the tire axial direction. Alternatively, the groove-bottom protrusion 50 may be provided to be positioned between two notches 70 provided on different center ribs 20. With the pneumatic tire 1 having such a configuration, the stone-bite can be suppressed, and the rigidity of a portion having the rigidity reduced due to the formation of the notch 70 can be improved for a better rigidity balance, resulting in improvement in resistance to uneven wear.

The groove-bottom protrusion 50 may be provided to oppose in the tire axial direction over an entire length of the length in the tire circumferential direction of the notch 70, or to oppose in the tire axial direction over a part of the length in the tire circumferential direction of the notch 70. In other words, the groove-bottom protrusion 50 may be provided to completely overlap the notch 70 in the tire axial direction, or to partially overlap the notch 70 in the tire axial direction. In this case, the groove-bottom protrusion 50 may be provided to overlap a plurality of notches 70 in the tire axial direction, or to overlap one notch 70 in the tire axial direction.

In the center primary groove 10 of the tread 2, the groove-bottom protrusion 50 may be provided only on the line of extension of the axial groove 30, or only at a position opposing the notch 70. Further, one groove-bottom protrusion 50 may be provided to overlap in the tire radial direction lines of extension of a plurality of axial grooves 30. Alternatively, one groove-bottom protrusion 50 may be provided on the line of extension of the axial groove 30 and opposing the notch 70. Desirably, in the center primary groove 10, the groove-bottom protrusions 50 are provided both on the line of extension of the axial groove 30 and at the position opposing the notch 70. A part of the plurality of groove-bottom protrusions 50 may exist at a position which is neither the position on the line of extension of the axial groove 30 nor the position opposing the notch 70. Desirably, the plurality of groove-bottom protrusions 50 formed on the center primary groove 10 only include two kinds, that is, the groove-bottom protrusions 50 existing on the line of extension of the axial groove 30, and the groove-bottom protrusions 50 existing at the positions opposing the notch 70.

As shown in FIG. 5, the groove-bottom protrusion 50 may include a flat surface 52 formed in parallel to the tire radial direction, and a curved surface 51 formed at a base end part with the center primary groove 10. The curved surface 51 is a surface curved in a manner to be convex toward an inner side of the groove-bottom protrusion 50, and is provided over an entire side of the base end part of the groove-bottom protrusion 50. According to such a configuration, it becomes easier to distribute the stress applied to the groove-bottom protrusion 50. With this configuration, rigidity near the groove-bottom protrusion 50 can be further improved for a better rigidity balance over the entirety of the tread 2, resulting in suppression of uneven wear.

In the groove-bottom protrusion 50, a length in the tire radial direction (height) is desirably greater than or equal to 1.5 mm and less than or equal to 5.0 mm, and is more desirably greater than or equal to 2.0 mm and less than or equal to 4.0 mm. The height of the groove-bottom protrusion 50 may be, for example, 2.5 mm. The height of the groove-bottom protrusion 50 is a length in the tire radial direction from the groove bottom (groove-bottom surface 10A) of the center primary groove 10 to the highest part of the groove-bottom protrusion 50.

Desirably, two or more and six or less groove-bottom protrusions 50 are provided within one pitch. For example, three groove-bottom protrusions 50 are provided within one pitch. A length in the tire circumferential direction of the groove-bottom protrusion 50 is determined, for example, based on the number of the groove-bottom protrusions 50 provided within one pitch. The length in the tire circumferential direction of the groove-bottom protrusion 50 is desirably greater than or equal to 15% and less than or equal to 40% of the length in the tire circumferential direction of one pitch. The length in the tire circumferential direction of the groove-bottom protrusion 50 may be, for example, 27% of the length in the tire circumferential direction of one pitch. Alternatively, the lengths in the tire circumferential direction of the plurality of groove-bottom protrusions 50 may differ from each other.

A length in the tire axial direction of the groove-bottom protrusion 50 is desirably greater than or equal to 15% and less than or equal to 40% of the length in the tire axial direction of the center primary groove 10. Moreover, the length in the tire axial direction of the groove-bottom protrusion 50 may be equal to, or less than or equal to a length in the tire axial direction of the groove-bottom surface 10A. Here, the length in the tire axial direction of the groove-bottom protrusion 50 is a length including the curved surface 51.

As shown in FIGS. 1 and 3, on the shoulder rib 21, a one-side-closed sipe 80 which opens to the shoulder primary groove 11 and which is closed in the shoulder rib 21 is provided. The one-side-closed sipe 80 is a groove having a smaller length in the tire axial direction and a smaller groove width in relation to the axial groove 40. According to such a configuration, sliding at an edge portion of the shoulder rib 21 is suppressed, and resistance to uneven wear can be improved.

A length in the tire axial direction of the one-side-closed sipe 80 is greater than or equal to 1% and less than or equal to 10% of the length in the tire axial direction of the shoulder rib 21, and is more desirably greater than or equal to 3% and less than or equal to 6% of the length in the tire axial direction of the shoulder rib 21. The length in the tire axial direction of the one-side-closed sipe 80 may be, for example, 4% of the length in the tire axial direction of the shoulder rib 21.

The depth of the one-side-closed sipe 80 is greater than or equal to 50% and less than or equal to 90% of the depth of the shoulder primary groove 11, and is more desirably greater than or equal to 60% and less than or equal to 80% of the depth of the shoulder primary groove 11. The depth of the one-side-closed sipe 80 may be, for example, 70% of the depth of the shoulder primary groove 11.

The one-side-closed sipe 80 is desirably disposed with a spacing in the tire circumferential direction which is greater than or equal to 10% and less than or equal to 30% of the length in the tire circumferential direction of one pitch. The one-side-closed sipe 80 may be disposed, for example, with a spacing in the tire circumferential direction of 14% of the length in the tire circumferential direction of one pitch. Further, the one-side-closed sipe 80 is desirably formed also in the axial groove 40.

On the center rib 20, a one-side-closed sipe 81 which opens to the shoulder primary groove 11 and which is closed in the center rib 20 is provided. The one-side-closed sipe 81 is a groove having a smaller length in the tire axial direction and a smaller groove width in relation to the axial groove 30. According to such a configuration, sliding at an edge portion of the center rib 20 is suppressed, and resistance to uneven wear can be improved.

A length in the tire axial direction of the one-side-closed sipe 81 is greater than or equal to 1% and less than or equal to 10% of the length in the tire axial direction of the center rib 20, and is more desirably greater than or equal to 3% and less than or equal to 6% of the length in the tire axial direction of the center rib 20. The length in the tire axial direction of the one-side-closed sipe 81 may be for example, 4% of the length in the tire axial direction of the center rib 20. Alternatively, the length in the tire axial direction of the one-side-closed sipe 81 may be for example, greater than or equal to 1.5 mm and less than or equal to 3.5 mm.

The depth of the one-side-closed sipe 81 is greater than or equal to 50% and less than or equal to 90% of the depth of the center primary groove 10, and is more desirably greater than or equal to 60% and less than or equal to 80% of the depth of the center primary groove 10. The depth of the one-side-closed sipe 81 may be, for example, 70% of the depth of the center primary groove 10.

The one-side-closed sipe 81 is desirably disposed with a spacing in the tire circumferential direction which is greater than or equal to 10% and less than or equal to 30% of the length in the tire circumferential direction of one pitch. The one-side-closed sipe 81 may be disposed, for example, with a spacing in the tire circumferential direction of 14% of the length in the tire circumferential direction of one pitch. When the sipe 34 is formed in the axial groove 30, the one-side-closed sipe 81 is desirably not formed in the axial groove 30.

The one-side-closed sipes 80 and 81 may be formed with similar spacings in the tire circumferential direction, or with different spacings in the tire circumferential direction. When the one-side-closed sipes 80 and 81 are formed with similar spacings in the tire circumferential direction, desirably, the one-side-closed sipes 80 and 81 are formed in such a manner to oppose each other in the tire axial direction.

The above-described embodiment can be suitably modified in design within a range of not adversely affecting the objective of the present disclosure. For example, the center primary groove 10 and the shoulder primary groove 11 may be primary grooves which extend in the tire circumferential direction in a zigzag shape. The number of the center primary grooves 10 is not limited to a single groove, and a plurality of center primary grooves 10 may be provided. With this alternative configuration, the number of the center ribs 20 also changes. For example, when two center primary grooves 10 are provided, three center ribs 20 are formed. In this case, the groove-bottom protrusions 50 are desirably provided in each of the two center primary grooves 10.

### REFERENCE SIGNS LIST

1 pneumatic tire, 2 tread, 10 center primary groove, 10A groove-bottom surface, 10B curved surface, 10C flat surface, 10D inclined surface, 11 shoulder primary groove, 11A groove-bottom surface, 11B curved surface, 11C inclined surface; 20 center rib, 21 shoulder rib, 30, 40 axial groove, 31, 32, 41, 42 point of inflection, 33, 43 straight-line portion, 34 sipe, 50 groove-bottom protrusion, 51 curved surface, 52 flat surface, 60 narrow groove, 70 notch, 80, 81 one-side-closed sipe, CL tire equator, E ground-contacting end.

1. A pneumatic tire comprising
a tread pattern including:
shoulder primary grooves provided at respective end sides in a tire axial direction;
a center primary groove provided at a center side in the tire axial direction in relation to the shoulder primary groove; and
a plurality of ribs partitioned by the shoulder primary grooves and the center primary groove, wherein
an axial groove which extends primarily in the tire axial direction is formed on the plurality of ribs,
the axial groove includes a point of inflection, and is connected to at least one of the shoulder primary groove and the center primary groove,
adjacent ones of the axial grooves of the plurality of ribs are disposed in a shifted manner in a tire circumferential direction,
the ribs include shoulder ribs positioned at respective end sides in the tire axial direction in relation to the shoulder primary groove, and a center rib positioned at a center side in the tire axial direction in relation to the shoulder primary groove,
the center primary groove has a plurality of groove-bottom protrusions formed intermittently in the tire circumferential direction,
the groove-bottom protrusion is longer in the tire circumferential direction than in the tire axial direction, and
all or a part of the plurality of groove-bottom protrusions exists on a line of extension of the axial groove.

2. The pneumatic tire according to claim 1, wherein
an amount of shift in the tire circumferential direction of the axial grooves adjacent to each other over the center primary groove is smaller than an amount of shift in the tire circumferential direction of the axial grooves adjacent to each other over the shoulder primary groove.

3. The pneumatic tire according to claim 1, wherein
an amount of shift in the tire circumferential direction of the axial grooves adjacent to each other over the center primary groove is greater than or equal to 5% and less than or equal to 20% with respect to a length in the tire circumferential direction of one pitch.

4. The pneumatic tire according to claim 1, wherein
a notch having a triangular shape and which opens to the center primary groove is formed on the center rib, at a center part of a block separated by the center primary groove and the axial groove.

5. The pneumatic tire according to claim 4, wherein
a part of the plurality of groove-bottom protrusions exists at a position opposing the notch.

6. The pneumatic tire according to claim 1, wherein
a depth of the axial groove formed on the center rib is greater than or equal to 10% and less than or equal to 30% of a depth of the center primary groove.

7. The pneumatic tire according to claim 1, wherein
a sipe having respective ends connected to at least one of the center primary groove and the shoulder primary groove is provided on a groove bottom of the axial groove formed on the center rib.

8. The pneumatic tire according to claim 7, wherein
a total depth of the axial groove and the sipe formed on the groove bottom of the axial groove is greater than or equal to 50% and less than or equal to 90% of a depth of the center primary groove.

9. The pneumatic tire according to claim 1, wherein
a narrow groove which connects the axial grooves and which is inclined in the tire axial direction is provided on the center rib.

10. The pneumatic tire according to claim 9, wherein
when a straight line parallel to the tire circumferential direction is presumed, the narrow groove is inclined with an angle of greater than or equal to 5° and less than or equal to 30° with respect to the straight line.

11. The pneumatic tire according to claim 9, wherein
a depth of the narrow groove is greater than or equal to 10% and less than or equal to 30% of a depth of the center primary groove.

12. The pneumatic tire according to claim 1, wherein
the axial groove formed on the shoulder rib is connected to the shoulder primary groove and is closed in the shoulder rib.

13. The pneumatic tire according to claim 1, wherein
a depth of the axial groove formed on the shoulder rib is greater than or equal to 5% and less than or equal to 30% of a depth of the shoulder primary groove.

14. The pneumatic tire according to claim 1, wherein
a length in the tire axial direction of the shoulder rib is equal to, or is greater than or equal to a length in the tire axial direction of the center rib.

15. The pneumatic tire according to claim 1, wherein
a one-side-closed sipe which opens to the shoulder primary groove and which is closed in the shoulder rib is provided on the shoulder rib.

16. The pneumatic tire according to claim 15, wherein
a spacing in the tire circumferential direction of the one-side-closed sipe is greater than or equal to 10% and less than or equal to 30% of a length in the tire circumferential direction of one pitch.

17. The pneumatic tire according to claim 15, wherein
a length in the tire axial direction of the one-side-closed sipe is greater than or equal to 1% and less than or equal to 10% of a length in the tire axial direction of the shoulder rib.

18. The pneumatic tire according to claim 15, wherein
a depth of the one-side-closed sipe is greater than or equal to 50% and less than or equal to 90% of a depth of the shoulder primary groove.

19. The pneumatic tire according to claim 1, wherein
a one-side-closed sipe which opens to the shoulder primary groove and which is closed in the center rib is provided on the center rib.

20. The pneumatic tire according to claim 1, wherein
a height of the groove-bottom protrusion is greater than or equal to 1.5 mm and less than or equal to 5.0 mm.

21. The pneumatic tire according to claim 1, wherein
two or more and six or less groove-bottom protrusions are provided within one pitch.

22. The pneumatic tire according to claim 1, wherein
a length in the tire axial direction of the groove-bottom protrusion is greater than or equal to 15% and less than or equal to 40% of a length in the tire axial direction of the center primary groove.

23. The pneumatic tire according to claim 1, wherein
the center primary groove has a curved surface between a groove-bottom surface and the rib.

24. The pneumatic tire according to claim 1, wherein
the shoulder primary groove has a curved surface between a groove-bottom surface and the rib.
